(19) United States
(12) Patent Application Publication
(10) Pub. No.: US 2026/0285732 A1
(43) Pub. Date: Sep. 24, 2026

(54) METHOD FOR THE TREATMENT OF COMPLEX WASTE

(71) Applicant: SUEZ INTERNATIONAL, Paris La Défense Cedex (FR)

(72) Inventors: Pierre-Emmanuel PARDO, Paris La Défense Cedex (FR); Safwan AL AYOUBI, Paris La Défense Cedex (FR)

(73) Assignee: SUEZ INTERNATIONAL, Paris La Défense Cedex (FR)

(21) Appl. No.: 18/997,991

(22) PCT Filed: Jul. 28, 2023
(86) PCT No.: PCT/EP2023/071015

§ 371 Date: Jan. 23, 2025

(30) Foreign Application Priority Data
Jul. 29, 2022 (FR) FR2207898

(51) Int. Cl. C02F 11/08; C02F 11/18; C02F 101/10; C02F 101/16; C10J 3/82

(52) U.S. Cl. CPC C02F 11/086; C02F 11/18; C10J 3/82; C02F 2101/105; C02F 2101/16; C10J 2300/0923

(57) ABSTRACT

A method for treating a mixture M1 containing at least organic matter. The method involves pressurizing the mixture M1 at a pressure of 150 to 300 bar to obtain a mixture M1p. The mixture M1p is heated at a temperature ranging from 250° C. to 500° C. to obtain a mixture M2. The mixture M2 is separated to obtain a stream M3 enriched in inorganic matter and a stream M4 depleted of inorganic matter. The stream M4 depleted of inorganic matter is subjected to hydrothermal gasification to obtain a mixture M5 comprising gas and a liquid effluent. At least one fraction of mixture M5 is cooled and separated to separate the gas from the liquid effluent M5′ comprising ammonia. At least one fraction from each of M3 and M5′ are mixed to form a mixture M6. A fraction of M6 is precipitated to form struvite, which is recovered.

### TECHNICAL FIELD OF THE INVENTION

The invention relates to the field of treatment of complex waste, comprising organic and inorganic matter, such as aqueous waste, sludge, and sewage.

### STATE OF THE ART

Wastewater treatment is essential for environmental protection. A wastewater treatment plant is made up of two main parts: The treatment of wastewater and the treatment of the sludge resulting from water treatment.

The aim of wastewater treatment is to eliminate pollution, especially particulate pollution (also known as suspended solids), and in particular carbon, nitrogen and phosphorus pollution. A wastewater treatment plant can also recover resources-such as phosphorus- or generate energy, for example by producing biogas.

The recovery of resources is now a concern, as many types of elements are approaching scarcity: Recycling them is becoming increasingly critical.

This is the case for phosphorus, which is on the European Union's list of critical raw materials due to the gradual exhaustion of phosphate mines, increasing demand, and the non-substitutable properties of phosphorus. Phosphorus is a fertilizing element, indispensable to crops and irreplaceable. It is therefore advisable to recycle as much as possible.

Consequently, wastewater treatment plants have focused on phosphorus recovery.

Sludge from wastewater treatment plants has been recognized as an additional phosphorus sink.

Land application is considered the most practical option, but is associated with increased public concern about pollutants in sludge (e.g. pathogens, heavy metals, persistent organic pollutants and micropollutants).

Thermochemical sludge treatment, and above all incineration, would appear to be an alternative to conventional disposal methods. It offers significant advantages, such as deodorization, high efficiency, substantial waste volume reduction (around 90%), destruction of organic pollutants, and pathogen deactivation. More importantly, incineration generates solid residue in the form of ash, which is concentrated in phosphorus (P) (9-13%) comparable to phosphate rock.

Nevertheless, the ash from sludge incineration consists of a complex matrix of minerals in which phosphorus accumulates along with heavy metals, making it impossible to reuse the ash directly as fertilizer. What's more, the bioavailability of phosphorus in ash is restricted by its binding to minerals. Consequently, removing heavy metals and improving the bioavailability of phosphorus represent economically and ecologically laborious treatments for recovering phosphorus from ash.

There is therefore a real need to propose an alternative method for recovering the phosphorus present in sludge directly in a bioavailable form, such as struvite, which contains a low concentration of heavy metals owing to a precipitation step, all with a sustainable approach.

### SUMMARY OF THE INVENTION

The invention relates to a method for treating a mixture M1 comprising at least organic matter, said method comprising:
a) a step of pressurizing the mixture M1 at a pressure of 150 to 300 bar, preferably 170 to 210 bar, to obtain an mixture M1p,
b) a step of heating the mixture M1p at a temperature ranging from 250° C. to 500° C. to obtain a mixture M2,
c) a step of separating mixture M2 from step b) in order to obtain a stream M3 enriched in inorganic matter and a stream M4 depleted of inorganic matter,
d) a hydrothermal gasification step carried out on stream M4 depleted of inorganic matter in order to obtain a mixture M5 comprising gas and a liquid effluent,
e) a step of cooling and separating at least one fraction of mixture M5 resulting from the hydrothermal gasification of step d) in order to separate the gas from the liquid effluent M5′ comprising ammonia,
f) optionally a step of enriching at least one fraction of liquid effluent M5′ in ammonia in order to obtain an ammonia-enriched stream M5″ and an ammonia-depleted stream M8,
g) a step of mixing (i) at least one fraction of the inorganic-matter-enriched stream M3 obtained from step c) and (ii) at least one fraction of the liquid effluent M5′ or at least one fraction of the enriched stream M5″ resulting from step f) when it is present, to obtain a mixture M6,
h) a step of forming struvite from at least one fraction of mixture M6 in a precipitation reactor,
i) a step of recovering struvite at the outlet of the precipitation reactor, said treatment method comprising at least one step of injecting at least one magnesium salt into the mixture M1 before step a) and/or during step g) and/or during step h) and/or into the mixture M6 between steps g) and h),
   said mixing step g) optionally being carried out in the precipitation reactor.

In one embodiment of the method of the invention, the magnesium salt is selected from magnesium hydroxide, magnesium oxide, magnesium chloride, and mixtures thereof, preferably from magnesium hydroxide and magnesium oxide; even more preferably, the magnesium salt is magnesium hydroxide.

In one embodiment of the invention, the method comprises, upstream of step a), a step of hydrolysis of the mixture M1, carried out at a temperature ranging from 70 to 165° C. and at a pressure ranging from 2 to 8 bars, to obtain a mixture M1 h which will then be pressurized in step a).

In one embodiment of the invention, the method comprises heat exchange between the mixture M5 from step d) and the mixture M1 or M1p or M1 h upstream of heating step b).

In one embodiment of the method of the invention, the mixture M1 comprises from 5 to 50% by weight of solids, preferably from 15 to 25% by weight of solids, based on the total weight of the mixture M1.

In one embodiment of the method of the invention, the salt-enriched stream from step c) comprises phosphorus, preferably in a proportion ranging from 1 to 20% by weight, based on the total dry weight of the inorganic-enriched stream M3.

In one embodiment of the method of the invention, the liquid effluent M5′ comprises from 1 to 20 g/L of ammonia.

In one embodiment of the method of the invention, the ammonia enrichment step f) is carried out using heat.

Preferably, the heat comes from the mixture M5 from hydrothermal gasification d).

In one embodiment of the method of the invention, the ammonia enrichment step f) makes it possible to obtain an ammonia concentration in the liquid effluent M5″ at least 1.5 times greater than the ammonia concentration in the liquid effluent M5′, preferably an ammonia concentration in the liquid effluent M5″ at least two times greater than the ammonia concentration in the liquid effluent M5′, or even an ammonia concentration in the liquid effluent M5″ at least five times greater than the ammonia concentration in the liquid effluent M5′.

In one embodiment of the method of the invention, less than 75% of the volume, preferably less than 50% of the volume, of the liquid effluent M5′ from step e), or of the liquid effluent M5″ from step f) when implemented, is mixed in step g).

The invention also relates to an installation for implementing the treatment method according to the invention, said installation comprising:
a pressurization pump 3 supplied by the mixture M1 and comprising an outlet for the mixture M1p,
A heating device 2 with an inlet for the mixture M1p, possibly mixed with a magnesium salt Mg, and an outlet for the mixture M2,
A separation device 5 supplied with at least one fraction of the mixture M2 and comprising an inorganic-enriched stream outlet M3 and an inorganic-depleted stream outlet M4,
A hydrothermal gasification reactor 8 supplied by at least one fraction of the stream M4 from the separation device 5 and comprising a mixture outlet M5 comprising gas and a liquid effluent,
A cooling and separation device 9 downstream of the gasification reactor (8), supplied by at least one fraction of the mixture M5 from the reactor 8 and comprising at least one outlet for a gaseous effluent and at least one outlet for a liquid effluent M5′,
Optionally an ammonia enrichment device 10 supplied by at least one fraction of the liquid effluent M5′ and comprising an outlet for the enriched stream M5′ and an outlet for the depleted stream M8,
Optionally a mixing device 6 supplied by (i) at least one fraction of the stream M3 from the device 5 and by (ii) at least one fraction of the stream M5′ from the device 9 or at least one fraction of the stream M5″ from the device 10, and having at least one outlet for the mixture M6,
A precipitation reactor 7 comprising at least one inlet and at least one outlet, said precipitation reactor 7 potentially being supplied:
   Either by (i) at least a fraction of the stream M3 from the separation device 5 and by (ii) at least a fraction of the stream M5′ from the cooling and expansion device 9 or at least one fraction of the stream M5″ from the enrichment device 10,
   Or by the stream M6 from the mixing device 6 when present,
At least one injection device located:
   upstream of the pressurization pump 3 and/or
   in the mixing device 6 and/or
   downstream of the mixing device 6 and upstream of the precipitation reactor 7, and/or
   in the precipitation reactor 7.

In one embodiment, the installation according to the invention also comprises at least one hydrolysis reactor 4 upstream of the pressurization pump 3, said hydrolysis reactor having at least one inlet for the mixture M1 and at least one outlet for the hydrolysate M1h, said hydrolysate M1 h supplying the pressurization pump 3.

The invention makes it possible to recover phosphorus in the form of struvite from water treatment sludge in a direct method, with optimum yield, optimized heat management, and fewer deposits in the pipes.

The method also reduces the amount of heavy metals that might be recovered with the phosphorus.

### BRIEF DESCRIPTION OF THE FIGURES

FIG. 1 is a schematic representation of a treatment method according to the invention.

FIG. 2 is a schematic representation of a treatment method according to the invention.

FIG. 3 is a schematic representation of a treatment method according to the invention.

FIG. 4 is a schematic representation of a treatment method according to the invention.

FIG. 5 is a schematic representation of a treatment method according to the invention.

### DETAILED DESCRIPTION OF THE INVENTION

The invention relates to a method for treating a mixture M1 comprising at least organic matter, said method comprising:
a. a step of pressurizing the mixture M1 at a pressure of 150 to 300 bar, preferably 170 to 210 bar, to obtain an mixture M1p,
b. a step of heating the mixture M1p at a temperature ranging from 250° C. to 500° C., preferably from 350° C. to 450° C. to obtain a mixture M2,
c. a step of the separating the mixture M2 from step b), to obtain a stream enriched in inorganic matter M3 and a stream M4 depleted of inorganic matter,
d. a hydrothermal gasification step carried out on stream M4 depleted of inorganic matter in order to obtain a mixture M5 comprising gas and an aqueous liquid effluent,
e. a step of cooling and separating at least one fraction of mixture M5 resulting from the hydrothermal gasification of step d) in order to separate the gas from the liquid effluent M5′ comprising ammonia,
f. optionally, an ammonia enrichment step for at least one fraction of the liquid effluent M5′ from step e) to obtain an ammonia-enriched liquid stream M5″,
g. a step of mixing:
   at least one fraction of the inorganic-matter-enriched stream M3 obtained in step c) and
   at least one fraction of the ammonia-containing liquid effluent M5′ obtained in step e), or at least one fraction of the enriched stream M5″ obtained in step f) when present,
to obtain a blend M6,
h. a step of forming struvite from at least one fraction of the mixture M6 in a precipitation reactor,
i. a step of recovering struvite at the outlet of the precipitation reactor, said treatment method comprising at least one step of injecting at least one magnesium salt into the mixture M1 before step a) and/or during step g) and/or during step h) and/or into the mixture M6 between steps g) and h), said mixing step g) optionally being carried out in the precipitation reactor.

For the purposes of this invention, the expression “at least one fraction of X” has the same meaning as “all or part of X”. When referring to a part of a mixture or stream or gas, this expression refers to a certain proportion of said mixture or stream or gas. For example, in the sense of this expression, “each fraction of the mixture” or “each fraction of the stream” or “each fraction of the gas” will have the same composition.

Thus, for the purposes of the present invention, the expression “step X implemented on the entire stream M from step Y” means that steps X and Y are successive and that there is no intermediate separation step between steps X and Y, it being understood that the stream M could be cooled/heated between steps X and Y, in particular by heat exchange which could possibly involve a stream exchange.

### Mixture M1 Comprising at Least Organic Matter

The mixture M1 comprises at least organic matter Typically, the mixture M1 further comprises inorganic matter.

Inorganic matter comprises salts comprising anions such as phosphates, sulfates, chlorides, carbonates and hydrocarbonates, with counterions such as sodium, magnesium, calcium, ammonium and metals.

The mixture M1 can, for example, be selected from primary, biological, mixed or digested sludge from municipal and industrial wastewater treatment plants.

In one embodiment, the mixture M1 comprises from 5 to 50% by weight of solids, preferably from 15 to 25% by weight of solids, based on the total weight of the mixture M1.

In one embodiment, at least one magnesium salt is added to the mixture M1 in such a way that the magnesium is in a stoichiometric or superstoichiometric proportion. Preferably, the Mg/P molar ratio in the mixture M1 after addition of the magnesium salt ranges from 1/1 to 1.3/1.

For example, the phosphorus content of the mixture M1 can be measured before it is used in the pressurization step a). The phosphorus content is typically measured at atmospheric pressure.

The magnesium salt is preferably added upstream of the pressurization step a).

The magnesium salt can be selected from magnesium hydroxide (Mg(OH)2), magnesium oxide (MgO) or magnesium chloride (MgCl2). Preferably, the magnesium salt is magnesium hydroxide.

The magnesium salt can be added in a mixing device supplied on the one hand by the mixture stream M1 and on the other by the magnesium salt stream.

### Optional Hydrolysis Step and Optional Grinding Step

In one embodiment, the method according to the invention comprises a step of hydrolysis of the mixture M1 upstream of the pressurization step a).

The hydrolysis step can be carried out at a temperature ranging from 70 to 165° C. and at a pressure ranging from 2 to 8 bar.

The hydrolysis step reduces the mixture's viscosity. The hydrolysis step thus produces a mixture M1h, also known as the hydrolysate.

The hydrolysis step breaks down the organic matter, in particular by breaking chemical bonds and depolymerizing the organic matter through the effect of water.

The mixture M1 h will typically have a viscosity at least 2 times lower, preferably at least 4 times lower, even more preferably at least 10 times lower than the viscosity of the mixture M1.

Thus, the ratio between the viscosity of the mixture M1 and the viscosity of the mixture M1 h is at least 2, preferably at least 4, even more preferably at least 10.

The viscosity defined in the context of the present invention is a kinematic viscosity measured at the same temperature (e.g. 20° C.) using rheometers adapted to the viscosity to be measured (cylinder-cylinder, plane-plane) and by measuring the two viscosities at the same shear rate (in s⁻¹), typically taking care to eliminate turbulence problems and to comply with rheological rules (e.g. spacing between cylinders depending on particle size).

The hydrolysis step carried out on the mixture M1 can be implemented in one or more hydrolysis reactors in parallel or in series.

Said hydrolysis step enables the mixture M1 to be hydrolyzed by maintaining an average hydraulic residence time at the desired temperatures and pressures (preferably temperatures ranging from 70 to 165° C. and pressures ranging from 2 to 8 bar), it being understood that if the hydrolysis step is implemented in several hydrolysis reactors, the temperature may be identical or different in the different reactors, and similarly, the pressure may be identical or different in the different reactors.

Advantageously, the hydrolysis step will implement an internal energy recovery step, thus minimizing the thermal consumption of hydrolysis. For example, there could be an energy recirculation loop from the hot hydrolysate to the cold hydrolysate via, for example, expansion steam generation from the hot hydrolysate and injection into the cold hydrolysate or heat exchange.

At the end of the hydrolysis step, a hydrolysate M1 h is obtained, which is not necessarily at the temperatures and pressures desired for hydrolysis. Indeed, before leaving the hydrolysis step, the hydrolysate could possibly undergo a cooling and/or expansion step.

In particular, for example if hydrolysis is carried out at a high temperature, e.g. from 100 to 165° C., then it may be desirable to cool the hydrolysate to, for example, below 90° C., so that the stream M1 h has a lower temperature for pressurization in step a) of the method of the invention.

The extraction of the hydrolysate M1 h can be monitored by measuring viscosity.

In one embodiment, a controlled amount of steam can be injected into the hydrolysis reactor(s) and diffused through the mixture M1. This control can be carried out by measuring the temperature in the hydrolysis reactor. Once the setpoint temperature has been reached, steam injection can be stopped.

Steam can be injected:
upstream of hydrolysis in the inlet with a mixer of the dynamic mixer type, and/or
directly in the hydrolysis reactor, preferably in the lower part in a tangential manner to avoid sludge clogging, and/or
in a hydrolyzed sludge recirculation loop.

In one embodiment, during hydrolysis, the mixture M1 is mixed, for example stirred.

The hydrolysis reactor may be a batch reactor, with or without stirring.

In one embodiment implementing a hydrolysis step, at least one magnesium salt is added to the mixture M1 to be treated prior to entering the hydrolysis device.

In another embodiment implementing a hydrolysis step, at least one magnesium salt is added to the mixture M1 h downstream of the hydrolysis device.

Prior to pressurization, the treatment method may optionally comprise a step of grinding, preferably mechanical grinding.

When present, the step of grinding the mixture M1 can be carried out before, during or after hydrolysis. In the latter case, grinding is carried out on the mixture M1h.

When the method of the invention implements a hydrolysis step combined with a grinding step, then the method of the invention may optionally comprise a step of recirculating at least a fraction of the ground hydrolysate to the inlet of the hydrolysis step.

In one embodiment, the hydrolysis reactor(s) comprise(s) a recirculation loop equipped with a grinding device, enabling at least a fraction of the hydrolysate to be introduced into said grinding device and at least a fraction, preferably all, of the hydrolysate thus ground to be returned to the inlet of the hydrolysis step.

The purpose of this grinding step is to reduce the particle size of the mixture M1, typically so that the particle size of the solid fraction is less than 1000 μm, preferably less than 500 μm and more preferably less than 100 μm.

A particle size “less than X μm” means that 95% of solid particles are retained on a sieve with a square mesh size of X μm, and the remaining 5% are no larger than three times X μm.

In addition to the reduction in particle size, which minimizes downstream clogging, the grinding step homogenizes the mixture M1 and reduces viscosity, thus enabling much better control of method parameters for hydrothermal gasification.

Like the hydrolysis step, grinding and particle size reduction also contribute to biomass homogenization.

In high-pressure reactors, it is difficult to achieve mechanical agitation, and the viscosity reduction achieved by the hydrolysis and grinding steps also improves internal turbulence and hence homogenization in pressurized reactors.

### Pressurization Step a)

The treatment method according to the invention comprises a step of pressurizing the mixture M1 at a pressure ranging from 150 to 350 bar, said mixture M1 having optionally been previously mixed with at least one magnesium salt.

For pressurization, a pump is installed at the start of the line upstream of the heating, or at the outlet of the hydrolysis reactor when present.

The pump is provided downstream of the mixing device for mixing the mixture M1 with the magnesium salt.

The pressurized mixture M1 is hereinafter referred to as the mixture M1p.

### Heating Step b)

The treatment method according to the invention comprises a step of heating at a temperature ranging from 250 to 500° C., carried out on the mixture M1p.

The heating step can be carried out in a heating device. The device can be a continuous stirred tank reactor (CSTR) or a plug-flow reactor. This reactor can be provided with an external heating device or heated via an exchange with a heat transfer fluid.

The heating step produces a mixture M2.

Steps a) and b) produce a mixture M2 with a pressure of 150 to 350 bar, preferably 170 to 210 bar, and a temperature of 250° C. to 500° C., preferably 350° C. to 450° C.

### Separation Step c)

The method according to the invention comprises a step of the separating the mixture M2 from step b), to obtain an inorganic-enriched stream M3 and an inorganic-depleted stream M4.

For the purposes of this invention, “inorganic-enriched stream” means a stream comprising a mass proportion of inorganic matter greater than the mass proportion of inorganic matter in the mixture M2.

For the purposes of this invention, “inorganic-depleted stream” means a stream comprising a mass proportion of inorganic matter lower than the mass proportion of inorganic matter in the mixture M2.

The separation step is typically carried out in a separation device comprising a feed line for the mixture M2 from step a) and two outlet lines: (i) an extraction line for the inorganic-enriched stream M3 and (ii) an extraction line for the inorganic-depleted stream M4.

The separation device can be a gravitational or hydraulic cyclone-type separation device, typically fitted at the bottom with a continuous or intermittent discharge system.

In one embodiment, the mixture M1 comprises phosphorus and the inorganic-enriched stream M3 from step c) comprises at least 50% by weight of the total weight of phosphorus present in the mixture M1. In other words, at least 50% by weight of the phosphorus present in the mixture M1 is recovered in the inorganic-enriched stream M3 from step c).

In one embodiment, the mixture M1 comprises phosphorus and the salt-enriched stream M3 from step c) comprises phosphorus, preferably in a proportion ranging from 1 to 20% by weight, based on the total dry weight of the inorganic-enriched stream M3.

### Optional Pressurization Step and Optional Heating Step

In one embodiment, the treatment method according to the invention comprises an additional pressurization step implemented on the stream M4 upstream of the hydrothermal gasification step.

Preferably, the pressurization step a) is carried out at a pressure of 150 to 210 bar, and the additional pressurization step brings the mixture M4 from step c) to a pressure of 225 bar or more.

Prior art hydrothermal gasification methods operate with a single operating pressure. In an advantageous embodiment of the invention, the method of the invention implements two operating pressures. This two-pressure operation offers multiple advantages.

Firstly, only a fraction of the installation is placed under very high pressure (only the “second part”, after the additional pressurization), so construction costs are reduced, as are installation constraints.

Secondly, when heat is recovered from the stream M5 to preheat the mixture M1, M1p or M1h, the difference in pressure between the two streams means that a greater temperature difference (delta T) is maintained than would be the case if the two pressures were identical, thus promoting heat exchange. This results in a higher delta T, which is the force of heat exchange in the exchanger, and therefore a smaller exchanger.

In one implemented embodiment, the treatment method according to the invention further comprises a step of heating the stream M4, preferably to a temperature greater than or equal to 300° C., more preferably still to a temperature ranging from 400° C. to less than 600° C.

When the method includes an additional pressurization step, then preferably the method further comprises a step of heating the stream M4, preferably to a temperature ranging from 400° C. to less than 600° C.

The additional heating step can be carried out in a heating device selected from electric heating or indirect heating by hot combustion gases.

### Hydrothermal Gasification Step d)

The treatment method according to the invention comprise a hydrothermal gasification step carried out on the inorganic-depleted stream M4 to obtain a mixture M5 comprising gas and an aqueous effluent.

Hydrothermal gasification (HG) is a thermal depolymerization method used to convert organic matter present in a humid environment into a mixture comprising only small molecules under high to moderate temperature and pressure.

During the HG process, the carbon and hydrogen in an organic matter are thermochemically converted under near-critical or supercritical conditions. One part is converted into water-soluble compounds with low molar masses.

Another part is converted into gaseous products such as carbon dioxide (CO2), methane (CH4), dihydrogen (H2), carbon monoxide (CO), light hydrocarbons such as ethane (C2H6) and propane (C3H8).

During residence in the hydrothermal gasification reactor at temperatures below 400° C., the organic matter undergoes, among other reactions, hydrolysis-based decomposition, similar to the reactions occurring in the liquefaction method, but much more rapidly. This is because implementation under near-critical or supercritical conditions makes it possible to use the unique properties of supercritical water as a solvent, enabling homogeneous solvation and reaction conditions, leading to very high reaction kinetic speeds. As a result, a much shorter residence time and a much higher heating rate than in conventional hydrolysis are used, limiting or even avoiding the secondary condensation and polymerization reactions responsible for bio-oil and bio-char formation.

When the HG process runs at temperatures above 400° C., radical decomposition of polymers (involving in particular decarboxylation, deamination by breaking C—N bonds, and C—C or C—O cleavage) predominates, while endothermic steam reforming is the main reaction pathway for converting small molecules with 1-3 carbon atoms into carbon oxides and dihydrogen, and nitrogen into ammonia.

Methane is also produced by the methanation of CO and CO2, using dihydrogen.

Consequently, HG can be seen as a decomposition method transforming the organic residues present in the M4 stream into a more readily biodegradable matter and ammonia dissolved in the liquid phase.

The treatment conditions (in particular temperature, pressure, and to a lesser extent residence time) of the HG can be adjusted to not only produce a gaseous fraction containing CH4, CO, CO2 and H2 (syngas), but also to produce an aqueous effluent, containing mainly easily digestible compounds, notably carboxylic acids, on the one hand, and ammonia in the form of the ammonium salt of the carbonic acids produced, on the other.

It should be noted that HG is different from hydrothermal liquefaction (HTL), in particular in that the conversion rate and level of decomposition of organic matter in HTL are not as high as in HG, even when HG is carried out under moderate temperature conditions.

Under HTL conditions, the water still contains HO— and H3O+ ions, which initiate the hydrolysis of organic matter.

Hydrolysis only takes place on the surface of the cellulose compounds contained in the organic fraction, which dissolves very little in the subcritical medium, resulting in fairly low decomposition conversions.

Condensation reactions (comprising mainly Aldol condensation, alkylation or Friedel-Craft acylation) of intermediates are an important reaction pathway, leading to the formation of biocrude which is an oil (also called bio-oil) that can be used as a fuel, i.e. biocrude contains organic molecules containing 5 or more carbon atoms, typically from 8 to 16 carbon atoms. On the other hand, the liquid product of HG, on the other hand, contains mainly readily biodegradable compounds.

HG differs from pyrolysis in that it is carried out in a medium containing water, the water being in a supercritical or near-critical state.

HG differs from “conventional” gasification of organic materials in that “conventional” gasification reduces the carbon/hydrogen (C/H) mass ratio, resulting in products with increased calorific value, including a gas composed mainly of synthesis gas (mixture of H2/CO), bio-oil and/or carbonaceous solid (char).

In the method according to the invention, the hydrothermal gasification step is typically carried out in a hydrothermal gasification reactor, fed at the inlet with at least one fraction of inorganic-depleted stream M4 and comprising an outlet M5. The inorganic-depleted stream M4 may come directly from the separation device or from any additional heating step carried out on at least one fraction of the stream M4.

In one embodiment, the gasification reactor is a tubular reactor.

Preferably, the hydrothermal gasification step is carried out at a temperature below 600° C., preferably at a temperature ranging from 350° C. to less than 600° C., even more preferably ranging from 450 to less than 600° C.

Preferably, the hydrothermal gasification step is carried out at a pressure greater than or equal to 220 bar, preferably equal to or greater than 250 bar.

Preferably, the (overall) residence time of the inorganic matter-depleted stream M4 in HG step d) typically ranges from 1 min to 20 min, preferably from 2 min to 10 min, more preferably from 3 to 5 min.

In a preferred embodiment, the hydrothermal gasification step is carried out in the presence of a catalyst. Preferably, the catalyst is chosen from metals on activated carbon, such as ruthenium, nickel, palladium or platinum.

The catalyst can be in the form of a bed of solid particles within the gasification reactor.

Owing to the separation step c) of the method of the invention, which removes so-called “poison” compounds, any catalyst used in the hydrothermal gasification step will not be damaged by these harmful compounds, which could damage or deactivate the catalyst.

### Cooling and Separation Step e)

The treatment method according to the invention comprises a step of cooling and separating at least a fraction of the mixture M5 resulting from the hydrothermal gasification of step d) in order to obtain a gaseous effluent and a liquid effluent comprising ammonia.

The cooling step brings the mixture M5 to a temperature of 200° C. or less, preferably 120° C. or less, more preferably between 5° and 120° C.

The cooling device can be selected from a heat exchanger, flash, scrubber or Rankine cycle.

The separation step can be carried out in an expansion system to obtain a liquid effluent M5′ on the one hand and a gaseous effluent on the other.

In one embodiment, the liquid effluent M5′ comprises from 1 to 20 g/L of ammonia.

### Optional Ammonia Enrichment Step f)

In one embodiment, the treatment method according to the invention comprises a step of ammonia enrichment of at least one fraction of the liquid effluent M5′ comprising ammonia from step e) in order to obtain an ammonia-enriched stream M5″ and an ammonia-depleted stream M8.

For the purposes of this invention, “ammonia-enriched stream” means a stream with an ammonia content higher than the ammonia content of the M5′ liquid effluent.

For the purposes of this invention, “ammonia-depleted stream” means a stream with an ammonia content lower than the ammonia content of the M5′ liquid effluent.

In one embodiment, the ratio between the ammonia concentration in the enriched stream M5″ and the ammonia concentration in the incoming effluent M5′ is at least 1.5, preferably at least 2, more preferably at least 5.

In one embodiment, the ammonia-enriched stream at the end of step f) comprises from 1 to 20 g/l of ammonia.

In one embodiment, the ammonia-depleted stream M8 can be sent to a digester for a digestion step.

The enrichment step can be carried out in an enrichment device which may, for example, comprise one or more evaporative concentrators, or one or more membrane or stripping reactors.

Thus, according to an advantageous embodiment, when an enrichment step is implemented, then preferably the cooling and separation step e) is implemented so as to bring the liquid effluent M5′ to a temperature ranging from 75° C. to 200° C., preferably from 100 to 120° C. In this way, it is advantageous to conserve heat to improve the efficiency of the enrichment step.

In one embodiment, the ammonia enrichment step f) is carried out using heat, preferably heat recovered from the mixture M5 from hydrothermal gasification d).

In one embodiment, the heat present in the mixture M5 from step d) is recovered, said recovered heat preferably allowing the mixture M1 to be at least partially heated during step a).

Preferably, this heat recovery is implemented by heat exchange between the mixture M5 from step d) and the mixture M1 or M1 h upstream of heating step b).

When hydrolysis is implemented, then heat exchange can be implemented between the mixture M5 and the mixture M1 to enable the mixture M1 to be heated for the hydrolysis step, or between the mixture M5 and the mixture M1 h to enable the mixture M1 h to be heated for the heating step b).

In this way, the mixture M1 or M1 h can recover heat from the mixture M5, reducing the energy requirements of the method and cooling the mixture M5.

Typically, the ammonia requirement for struvite formation will generally be less than the amount of ammonia in the liquid effluent M5′ or in the liquid effluent M5″, so preferably only a fraction of the liquid effluent stream M5′ or the enriched liquid effluent stream M5″ will be mixed with at least a fraction of the stream M3 in step g). For example, less than 75% of the volume of M5′ or M5″, or even less than 50% of the volume of M5′ or M5″ can be used in the mixing step g).

### Mixing Step g)

The treatment method according to the invention comprises a step of mixing at least one fraction of the inorganic-enriched stream M3 obtained from step c) and at least one fraction of the ammonia-containing liquid effluent obtained from step e) or from step f) when present, to obtain a mixture M6.

In one embodiment, the entire inorganic-enriched stream M3 obtained in step c) is mixed in step g).

In one embodiment, all the ammonia-containing liquid effluent obtained in step e), or in step f) if present, is mixed in step g).

This mixing step g) is preferably carried out in a mixing device. The mixing device can be a batch, semi-continuous or continuous reactor, stirred by an agitation system such as a blade, propeller, draft tube or by recirculation external to the reactor.

This reactor is equipped with a pH meter and base/acid injection for pH control.

Preferably, the pH of the reactor is set so that the pH at room temperature ranges from 7.5 to 10, preferably from 8 to 9.

This mixing step g) is typically carried out at a temperature ranging from 50° C. to 250° C. and/or at a pressure ranging from 1 to 200 bar.

This mixing step may also be carried out in the precipitation reactor where struvite is formed.

Thus, according to this embodiment, at least one fraction of the inorganic-enriched stream M3 obtained at the end of step c) and at least one fraction of the liquid effluent comprising ammonia obtained at the end of step e) or at the end of step f) when it is present are introduced into the precipitation reactor and the mixture M6 is formed in situ in the precipitation reactor and the struvite formation step, step h) takes place.

In one embodiment, at least one magnesium salt is injected:
in the mixture during this step g) and/or
in the mixture M6 between steps g) and h) when carried out in separate devices and/or
when step g) is carried out in the precipitation reactor.

The magnesium salt can be selected from magnesium hydroxide (Mg(OH)2), magnesium oxide (MgO) or magnesium chloride (MgCl2). Preferably, the magnesium salt is magnesium hydroxide.

In one embodiment, at least one magnesium salt is added in such a way that the magnesium is in a stoichiometric or superstoichiometric proportion. Preferably, the Mg/P molar ratio in the mixture M6 after addition of the magnesium salt ranges from 1/1 to 1.3/1.

For example, the phosphorus content of the mixture M1 can be measured before it is used in the pressurization step a). The phosphorus content is typically measured at atmospheric pressure. This measurement in the mixture M1 will give a good estimate of the phosphorus content in the mixture M6.

A measurement of the phosphate content in the liquid effluent M7 will also enable adjustment of the magnesium salt content to be added to the mixture M6.

The magnesium salt can be added to a mixing device during this step g) and/or downstream of said mixing device in the mixture M6.

The mixing step g) can be carried out directly in the precipitation reactor.

In this embodiment, the precipitation reactor is supplied, on the one hand, with at least one fraction of the inorganic-enriched stream M3 obtained from step c) and, on the other hand, with:
at least one fraction of the liquid effluent M5′ comprising ammonia obtained in step e) or
at least one fraction of the enriched stream M5″ obtained at the end of step f) when present.

In this embodiment, the mixture will also be referred to as mixture M6.

In this embodiment, magnesium salt can be added to the precipitation reactor.

In one embodiment of the invention, the treatment method comprises:
a step of injecting a magnesium salt, preferably selected from MgO and Mg(OH)2 and mixtures thereof, into the mixture upstream of the pressurization step a), and
a step of injecting a magnesium salt, preferably chosen from MgCl2, into the mixture during step g) and/or during step h) and/or into the mixture M6 between steps g) and h) when they are carried out in separate devices.

### Struvite Formation Step h)

The treatment method according to the invention comprises a step of forming struvite from at least a fraction of the mixture M6 of step g) in a precipitation reactor.

The struvite formation step can be carried out at a temperature ranging from 20 to 250° C. and at a pressure ranging from 1 to 200 bar.

In one embodiment, the entire mixture M6 from step g) is used in this struvite formation step i). Of course, when the mixing step g) is carried out in the precipitation reactor, the entire mixture M6 will necessarily be used in this struvite formation step i).

When mixing step g) is carried out in a device separate from the precipitation reactor, then at least a fraction of the mixture M6, preferably all of the mixture M6, is injected into the precipitation reactor to carry out step i).

The precipitation reactor can be a perfectly mixed reactor or a fluidized bed reactor. An example of a commercial precipitation reactor, particularly useful for precipitating phosphorus in the form of struvite, is the Crystalactor®.

At the end of step h), struvite is recovered after optional settling.

It should be noted that in addition to struvite, this step h) will produce another effluent, a liquid effluent M7.

The invention also relates to an installation for implementing the method of the invention.

The installation according to the invention comprises:
a pressurization pump 3 supplied by the mixture M1 and comprising an outlet for the mixture M1p,
A heating device 2 with an inlet for the mixture M1p, possibly mixed with a magnesium salt Mg, and an outlet for the mixture M2,
A separation device 5 supplied with at least one fraction of the mixture M2 and comprising an inorganic-enriched stream outlet M3 and an inorganic-depleted stream outlet M4,
A hydrothermal gasification reactor 8 supplied by at least one fraction of the stream M4 from the separation device 5 and comprising a mixture outlet M5 comprising gas and a liquid effluent,
A cooling and separation device 9 downstream of the gasification reactor, supplied by at least one fraction of the mixture M5 and comprising at least one outlet for a gaseous effluent and at least one outlet for a liquid effluent M5′,
Optionally an ammonia enrichment device 10 supplied by at least one fraction of the liquid effluent M5′ and comprising an outlet for the enriched stream M5′ and an outlet for the depleted stream M8,
Optionally a mixing device 6 supplied by (i) at least one fraction of the stream M3 and by (ii) at least one fraction of the stream M5′ or at least one fraction of the stream M5″ and comprising an outlet for the stream M6,
A precipitation reactor 7 comprising at least one inlet and at least one outlet, said precipitation reactor 7 potentially being supplied:
   Either by (i) at least a fraction of the stream M3 from the separation device 5 and by (ii) at least a fraction of the stream M5′ from the cooling and expansion device 9 or at least one fraction of the stream M5″ from the enrichment device 10,
   Or by the stream M6 from the mixing device 6,
At least one injection device located:
   upstream of the pressurization pump 3 and/or
   in the mixing device 6 when present and/or
   downstream of the mixing device 6 when present and upstream of the precipitation reactor 7, and/or
   in the precipitation reactor 7.

In one embodiment, the installation according to the invention further comprises at least one hydrolysis reactor 4 upstream of the pressurization pump 3, said hydrolysis reactor having at least one inlet for the mixture M1 and at least one outlet for the hydrolysate M1h, said hydrolysate M1 h supplying the pressurization pump 3.

In one embodiment, the precipitation reactor 7 that can be supplied by (i) at least one fraction of the stream M3 from the separation device 5 and by (ii) at least one fraction of the stream M5′ from the cooling and expansion device 9 or at least one fraction of the stream M5″ from the enrichment device 10.

In this embodiment, the mixing step g) is implemented in the precipitation reactor 7 where the struvite formation step i) takes place.

In another embodiment, the installation comprises a mixing device 6 separate from the precipitation reactor 7. The mixing device 6 in such a case is supplied by (i) at least one fraction of the stream M3 and by (ii) at least one fraction of the stream M5′ or at least one fraction of the stream M5″ and comprising an outlet for the stream M6. In this configuration, the precipitation reactor 7 is supplied by the stream M6 from the mixing device 6.

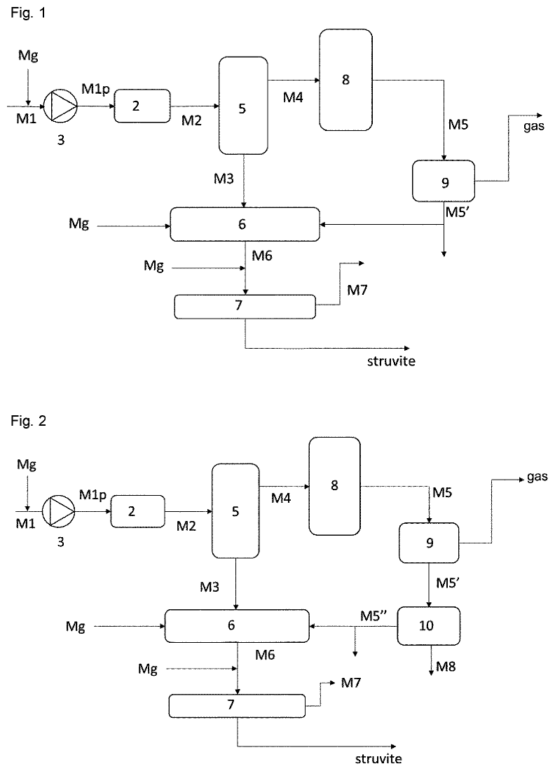

FIGS. 1 to 3 each illustrate an embodiment of the system according to the invention and the method according to the invention, without limiting their scope.

As shown in FIG. 1, the mixture M1, optionally additivated with a magnesium salt Mg, is pressurized by a pressurization pump 3 and then fed into a heating device 2, where the mixture M1 is typically pressurized to a pressure of 150 to 350 bar, that mixture being known as M1p, and then heated to a temperature of 250 to 500° C. At the outlet of the heating device 2, a mixture M2 is obtained.

As shown in FIG. 1, the mixture M2 is fed to a separation device 5 to obtain a stream enriched in inorganic matter M3 and a stream depleted of inorganic matter M4.

As shown in FIG. 1, the stream M4 is fed into a hydrothermal gasification reactor 8 to obtain a mixture M5 comprising gas and liquid effluent. The gasification reactor 8 may comprise a catalyst.

As shown in FIG. 1, the mixture M5 is fed to a cooling and separation device 9, which cools the mixture M5 to a temperature of 200° C. or less, producing a gaseous stream and a liquid effluent M5′.

As shown in FIG. 1, the installation comprises a mixing device 6 fed on the one hand by the stream M3 and on the other hand by at least part of the stream M5′ leaving the cooling and separation device 9.

As shown in FIG. 1, the mixture M6 from the mixing device, optionally additivated with a magnesium (Mg) salt, is then introduced into a precipitation reactor 7.

Struvite is then recovered downstream of the precipitation reactor 7, after optional settling not shown, along with a liquid effluent M7.

It should be noted that the installation according to the invention may comprise other elements not shown in the Figures. In particular, the system according to the invention may comprise valves and bypass pipes, enabling only a fraction of the streams to be introduced rather than all the streams, as shown in the Figures for simplicity, in particular for streams M3, M4, M5 or M6.

Control elements can also be provided to control the flow rate.

The Figures illustrate several steps in the addition of magnesium salt, but it should be noted that the installation according to the invention may comprise a single device or several devices for adding magnesium salt. Such a device may comprise a magnesium salt storage tank and a supply line for conveying the magnesium salt from the tank to the injection site.

The embodiment shown in FIG. 2 differs from the embodiment shown in FIG. 1 in that an enrichment device 10 is present, said enrichment device being located downstream of the cooling device 9 and upstream of the mixing device 6.

The enrichment device 10 has an inlet for at least one fraction of the liquid effluent M5′, an outlet for the enriched effluent M5″ and an outlet for the depleted effluent M8.

In this embodiment, the system according to the invention preferably comprises a bypass valve for controlling the quantity of effluent M5″ introduced into the mixing device 6.

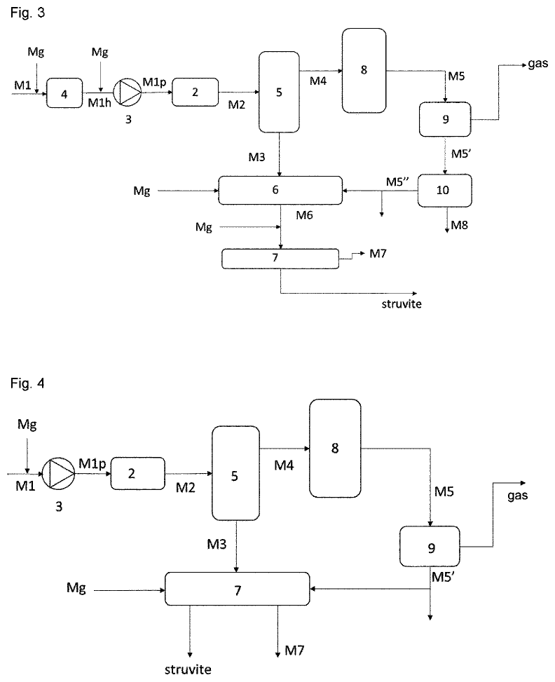

The design shown in FIG. 3 differs from the design shown in FIG. 2 in that a hydrolysis reactor 4 is present, upstream of the pressurization pump 3.

In one embodiment of the invention, the installation comprises at least one hydrolysis reactor 4 upstream of the pressurization pump 3.

The installation may comprise one or more hydrolysis reactors 4 in series or in parallel, supplied by an inlet line for the mixture M1 and an outlet line for the hydrolyzed mixture M1 h at a temperature less than or equal to the hydrolysis temperature. The hydrolysis reactor(s) 4 advantageously comprise(s) a heating and pressurizing device and optionally a stirring device, as well as advantageously an internal heat recovery device.

In this embodiment, the pump 3 is supplied with the mixture M1h.

The magnesium salt can be injected upstream or downstream of the hydrolysis reactor(s) 4.

The hydrolysis reactor(s) 4 may be preceded by a grinding device, or may be provided with a recirculation loop equipped with a grinding device, or may be followed by a grinding device, upstream of the pump 3.

In the embodiment shown in FIG. 4, the precipitation reactor 7 is supplied with (i) at least one fraction of the stream M3 from the separation device 5 and (ii) at least one fraction of the liquid effluent M5′ from the cooling and expansion device 9. In this embodiment, a magnesium salt can be injected into the precipitation reactor 7 and/or into the M1 or mixture M1h (hydrolysis upstream of pressurization via pump 3 is not shown in FIG. 4 but is part of the invention).

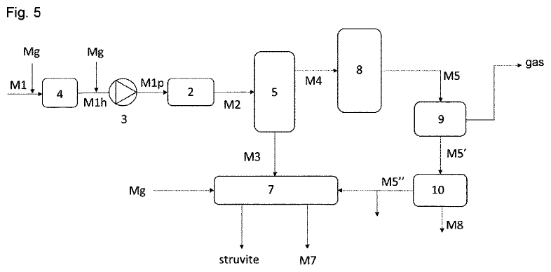

In one embodiment shown in FIG. 5, the precipitation reactor 7 is supplied with (i) at least one fraction of the stream M3 from the separation device 5 and (ii) one fraction of the stream M5″ from the enrichment device 10. In this embodiment, a magnesium salt can be injected into the precipitation reactor 7 and/or into the M1 or mixture M1h.

The system according to the invention may of course comprise one or more of the features described as part of the method according to the invention.

1. A method for treating a mixture M1 comprising at least organic matter, the method comprising:
a) pressurizing the mixture M1 at a pressure of 150 to 300 bar to obtain a mixture M1p
b) heating the mixture M1p at a temperature ranging from 250° C. to 500° C. to obtain a mixture M2;
c) separating mixture M2 from step b) in order to obtain a stream M3 enriched in inorganic matter and a stream M4 depleted of inorganic matter;
d) carrying out hydrothermal gasification on stream M4 depleted of inorganic matter to obtain a mixture M5 comprising gas and a liquid effluent;
e) cooling and separating at least one fraction of mixture M5 resulting from the hydrothermal gasification of step d) in order to separate the gas from the liquid effluent M5′ comprising ammonia;
f) optionally enriching at least one fraction of liquid effluent M5′ in ammonia to obtain an ammonia-enriched stream M5″ and an ammonia-depleted stream M8;
g) mixing (i) at least one fraction of the inorganic-matter-enriched stream M3 obtained from step c) and (ii) at least one fraction of the liquid effluent M5′ or at least one fraction of the enriched stream M5″ resulting from step f) when it is present, to obtain a mixture M6;
h) forming struvite from at least one fraction of mixture M6 in a precipitation reactor; and
i) recovering struvite at an outlet of the precipitation reactor,
wherein the method further comprises injecting at least one magnesium salt into the mixture M1 before step a) and/or during step g) and/or during step h) and/or into the mixture M6 between steps g) and h).

2. The method according to claim 1, wherein the magnesium salt is at least one selected from the group consisting of magnesium hydroxide, magnesium oxide, magnesium chloride, and mixtures thereof.

3. The method according to claim 1, further comprising:
hydrolyzing the mixture M1, upstream of step a), at a temperature ranging from 70 to 165° C. and at a pressure ranging from 2 to 8 bars, to obtain a mixture M1h which will then be pressurized in step a).

4. The method according to claim 1, further comprising:
heat exchanging between the mixture M5 from step d) and the mixture M1 or M1p or M1h upstream of the heating step b).

5. The method according to claim 1, wherein the mixture M1 comprises from 5 to 50% by weight of solids, based on the total weight of the mixture M1.

6. The method according to claim 1, wherein the salt-enriched stream from step c) comprises phosphorus.

7. The method according to claim 1, wherein the liquid effluent M5′ comprises from 1 to 20 g/L of ammonia.

8. The method according to claim 1, wherein the ammonia enrichment step f) is carried out using heat.

9. The method according to claim 8, wherein the heat comes from the mixture M5 from hydrothermal gasification d).

10. The method according to claim 1, wherein the ammonia enrichment step f) makes it possible to obtain an ammonia concentration in the liquid effluent M5″ at least 1.5 times greater than the ammonia concentration in the liquid effluent M5′.

11. The method according to claim 1, wherein less than 75% of the volume of the liquid effluent M5′ from step e), or of the liquid effluent M5″ from step f) when implemented, is mixed in step g).

12. An installation for carrying out the method of claim 1, the installation comprising:
a pressurization pump supplied by the mixture M1 and comprising an outlet for the mixture M1p;
a heating device with an inlet for the mixture M1p and an outlet for the mixture M2;
a separation device supplied with at least one fraction of the mixture M2 and comprising an inorganic-matter-enriched stream outlet M3 and an inorganic-depleted stream outlet M4;
a hydrothermal gasification reactor supplied by at least one fraction of the stream M4 from the separation device and comprising a mixture outlet M5 comprising gas and a liquid effluent;
a cooling and separation device downstream of the gasification reactor, supplied by at least one fraction of the mixture M5 from the reactor and comprising at least one outlet for a gaseous effluent and at least one outlet for a liquid effluent M5′;
a precipitation reactor comprising at least one inlet and at least one outlet; and
at least one injection device located:
upstream of the pressurization pump,
in the mixing device,
downstream of the mixing device and upstream of the precipitation reactor, and/or
in the precipitation reactor.

13. The installation according to claim 12, further comprising:
at least one hydrolysis reactor upstream of the pressurization pump, the hydrolysis reactor having at least one inlet for the mixture M1 and at least one outlet for the hydrolysate M1h, the hydrolysate M1h supplying the pressurization pump.

14. The method according to claim 1, wherein the pressurizing of step a) is at a pressure of from 170 to 210 bar.

15. The method according to claim 1, wherein the mixing step g) is carried out in the precipitation reactor.

16. The method according to claim 5, wherein the mixture M1 comprises from 15 to 25% by weight of solids, based on the total weight of the mixture M1.

17. The method according to claim 6, wherein the phosphorus is present in the salt-enriched stream from step c) in a proportion ranging from 1 to 20% by weight, based on the total dry weight of the inorganic-enriched stream M3.

18. The installation according to claim 12, further comprising:
an ammonia enrichment device supplied by at least one fraction of the liquid effluent M5′ and comprising an outlet for the enriched stream M5′ and an outlet for the depleted stream M8.

19. The installation according to claim 12, further comprising:
a mixing device supplied by (i) at least one fraction of the stream M3 from the device and by (ii) at least one fraction of the stream M5′ from the device or at least one fraction of the stream M5″ from the device, and having at least one outlet for the mixture M6.

20. The installation according to claim 12, wherein the precipitation reactor is supplied by (i) at least a fraction of the stream M3 from the separation device and by (ii) at least a fraction of the stream M5′ from the cooling and expansion device or at least one fraction of the stream M5″ from the enrichment device, or
wherein the precipitation reactor is supplied by the stream M6 from the mixing device when present.
